(19) United States
(12) Patent Application Publication
(10) Pub. No.: US 2003/0127952 A1
(43) Pub. Date: Jul. 10, 2003

(54) Assembly for the physical manipulation of potentially contaminated articles

(76) Inventor: Miguel Friedenbach, Buenos Aires (AR)

Correspondence Address: J. DAVID DAINOW, AMSTER, ROTHSTEIN & EBENSTEIN, 90 PARK AVENUE, NEW YORK, NY, 10016, US

(21) Appl. No.: 10/293,889

(22) Filed: Nov. 13, 2002

Related U.S. Application Data
(60) Provisional application No. 60/337,649, filed on Nov. 13, 2001.

(51) Int. Cl. A61G 11/00

(52) U.S. Cl. 312/1

(57) ABSTRACT

An isolation assembly comprising an at least partially transparent housing including a hollow interior compartment viewable through the housing and having an access opening selectively disposed between an open and closed position. At least one but preferably two hand covers are disposed in an operative position within the interior of the compartment so as to handle a potentially contaminated article therein, such as a letter, parcel, or other mailed article. The housing, hand covers, access opening and other operative components of the isolation assembly are formed from a pathogen impermeable material and are otherwise structured to isolate both aerosol and particulate contaminants within the compartment in the event the article being handled is contaminated.

### BACKGROUND OF THE INVENTION

1. Field of the Invention

The present invention is directed to an isolation assembly structured to receive and permit the safe, isolated, physical manipulation of an article, including a letter, parcel, package, laboratory element, hazardous product, toxic product, allergenic product, hobby work, etc. for purposes of manipulating, examining, working, etc., for purposes of determining whether or not the article is contaminated. The isolation assembly is preferably light weight, portable and adaptable for use in any location, at home, the industry, camping, etc.

While the present application will make reference to the application of the assembly in the examination of potentially hazardous or dangerous articles, such as a letter, for determining whether or not the article is contaminated, it must be understood that the assembly of the invention is well applicable to many other activities and such applications are under the scope of protection of the present claims. Such applications may be: for manipulating an article by a person without the person being exposed directly to the article, for storing blood-stained elements in hospitals, laboratories, etc., for collecting and manipulating police evidence such as in crime scenes, for storing such proofs and evidences under safety conditions by using PP, adhesives, etc., for taking, manipulating, storing hazardous and /or toxic samples in laboratories and hospitals, such as syringes, blood, urine samples, for manipulating allergenic articles by allergic and/or obsessive persons, for assembling, adhering and painting small pieces in hobby activities, for polluting activities such as sandpapering, polishing, etc. of articles producing dust, for manipulating poisons, for manipulating aggressive products such as chopping up garlic, peeling onions, etc.

2. Description of the Related Art

The development and use of a variety of collection devices or assemblies which are designed to facilitate the handling, removal and/or disposal of various objects or substances is well known. Such collection devices are generally structured to allow collection of the object in a manner which avoids direct physical contact therewith. Different categories of such collection devices are intended for use in a variety of areas including industries associated with food service, cosmetics, skin and hair treatment and medical care facilities. In addition, known collection devices are also frequently used by individuals to permit the collection and disposable of animal feces in a sanitary manner, including minimizing direct exposure to the substances being collected.

Typically, collection devices of the type described above incorporate what is commonly referred to as a “glove bag” construction. More specifically, a commonly designed device of this type includes a single glove, mitten or like member connected to a bag or other flexible material container. In use, the hand of the user is passed into the interior of the glove or like hand receiving structure and extended outwardly from the interior of the bag or container in gripping or otherwise engaging relation to the object being collected. The bag, being formed of a flexible material, is then passed over the glove covered hand of the user so as to surround the material being collected. Once properly contained within the interior of the bag, the entire collection device can be disposed of in a manner which eliminates direct contact and otherwise minimizes exposure of the user to the object or substance being collected.

More sophisticated or complex structures associated with similar type collection devices comprise handles or hand operated components that serve to support the bag or like collection container. Others of the known or currently existing collection devices include bags or containers of a specific configuration which are intended to be used as part of a kit or a general collection assembly. These known collection assemblies sometimes include scoops, scrapers or other tools which further facilitate the collection of various substances or objects.

Even more sophisticated collection devices are primarily designed to protect a user against hazardous material such as, but not limited to, asbestos insulation material, wherein such material is either being installed or removed. These types of known devices typically assume a somewhat “body drape” or like structure which comprises elongated sleeves having gloves, mittens, or like hand receiving structures secured to an outer most end thereof. Therefore, these protective drape structures are intended to cover and protect a significant portion of the user's body, in addition to the hands, from direct exposure to the asbestos insulation or other hazardous material.

While it is assumed that known structures of the type described above are at least minimally operative for their intended function and purpose, such structures are primarily designed to only protect a user against physical contact. Moreover, such known devices are not readily adaptable for use for either domestic or industrial applications, wherein individuals may be exposed to articles which are contaminated or potentially contaminated with any of a variety of different pathogens.

Recent terrorist activity directed against the United States and its citizens, in addition to causing catastrophic property damage and extensive loss of life, has extended to the deliberate contaminating of letters and other articles which are distributed by the postal service. Most prominently, mailed letters and possibly other parcels, packages, etc. have been purposely contaminated with anthrax in the form of a powder or like particulate material. Such material comprise particles of a sufficiently small size to pass through the pores of the envelopes in which they are contained. As a result, the contaminated material becomes airborne or otherwise disbursed in a manner which facilitates the contraction of any associated pathogens by individuals handling the mailed article or being the recipient thereof.

The distribution of such contaminated articles have not only caused the death and illness of many individuals but has instilled a significant degree of fear in a much larger segment of the population. Naturally, postal workers and others directly associated with the handling and distribution of mailed articles are more apprehensive than the general public. However, even those individuals not directly associated with the postal service or related activities are at least hesitant, if not fearful, of coming into the direct contact with mailed articles in general and any suspicious letters, parcels, etc. in particular.

Accordingly, there is an obvious and immediate need for an isolation assembly serving to protect individuals from coming into direct contact or otherwise being exposed to a variety of different contaminants which may affect an individual either by contact or by inhalation. An isolation assembly of the type referred to should therefore be capable of being utilized on a wide scale, by individuals directly associated with the collection, distribution and other activities associated with any kind of articles, such as mailed articles, including but not limited to postal workers. Further a preferred isolation assembly of the type referred to hereinafter should also be easily adapted for use by individuals in either a business or domestic environment. As such, a variety of articles can be examined or manipulated in an isolated and completely safe manner. The design and structure of such a preferred isolation assembly should be such as to be easily usable by an individual with minimal or no instructions. Further, such an improved isolation assembly should be disposable after examination of an article whether the article is found to be contaminated or not. Finally, a preferred assembly should be formed of a material which facilitates isolation of a contaminated and/or hazardous article while having sufficient structural integrity to be resistant to tearing, penetration or like failure.

### SUMMARY OF THE INVENTION

It is an object of the invention to provide an assembly for handling and/or manipulating under isolation conditions articles that may be harmful, hazardous or dangerous for a person that is handling and/or manipulating the article, wherein the assembly provides a compartment for receiving the article, means for sealing and isolating the compartment from the surroundings, and means for manipulating the article that is housed in the compartment.

The present invention is directed to an isolation assembly specifically structured to safely manipulate, examine and handle contaminated articles or articles believed to be contaminated. The type of articles to be examined are primarily intended to include articles collected, distributed and otherwise processed by the postal service of the United States or the other countries. However as will be apparent from a detailed description of the structure and function of the subject isolation assembly, a variety of other articles can be safely examined without exposing an individual to any contaminants which may be associated therewith. Further, the isolation assembly of the present invention is specifically structured to protect a user, as well as the surrounding environment, from contamination by a variety of different pathogens regardless of the specific physical form the contaminated material may assume. Moreover, isolation of an article during its physical examination, utilizing the isolation assembly of the present invention, will protect the user and surrounding area from exposure to aerosol or particulate contaminants and any pathogens associated therewith.

More specifically, the isolation assembly of the present invention comprises a housing formed in whole or in part a transparent material and including an at least partially hollow compartment formed on the interior thereof. An access opening is formed on the housing in direct communication with the interior compartment and is specifically dimensioned and configured to allow the passage of articles to pass therethrough into and out of the compartment.

The access opening is structured, either independently or in direct association with a closure assembly, to be selectively disposed between an open position and a closed position. Further, when in the closed position the interior compartment will be sufficiently sealed to hermetically isolate the interior compartment and any article contained therein. As will be explained in greater detail hereinafter, the access opening and any associated closure assembly may comprise anyone of a variety of structures which facilitate the opening and closing of the compartment as well as easily and reliably establishing the aforementioned air tight seal.

Another feature of the various preferred embodiments of the present invention is the provision of a handling assembly mounted on the housing. The handling assembly is structured to facilitate the physical examination and manipulation of an article contained within the interior compartment, without coming into direct contact therewith. Also, due to transparency of at lest a portion of the housing, the article can be clearly observed during the physical examination. The handling assembly of the present invention comprises at least one hand cover secured to the housing so as to be normally disposed in an operative position. However, in a most preferred embodiment the handling assembly comprises at least two hand covers each connected to the housing and normally extendable into the interior of the compartment when in their aforementioned operative position. In any case, the isolation assembly is preferably transparent, light weight, portable and adaptable for use in locations encountering heavy mail traffic or for an individual's use at home by itself or in association with a conventional mailbox.

Various additional preferred embodiments of the present invention comprise the one or more hand covers disposed in spaced relation to the access opening. In addition, when two of the hand covers are utilized, they are disposed in spaced relation to one another and in spaced relation to the access opening at least a predetermined distance. Such predetermined distance and the manner in which the hand covers are connected to the housing, at least partially restricts the inadvertent passage of the one or more hand covers through the aforementioned access opening. The possibility of contaminating the surrounding area if and when a contaminated article is being examined is thereby further reduced. As will also be explained in greater detail hereinafter, each of the one or more hand covers may assume a substantially ergonomically correct structural configuration such as, but not limited to a glove, mitten, etc. Alternatively, the specific configuration and overall structure of one or more hand members may include a more abstract configuration not specifically resembling or corresponding to a multi-finger shape or workings of a person's hand.

The versatility of the isolation assembly of the present invention is further demonstrated by its ability to be used in association with a conventional mailbox. By way of example, the handling assembly, normally disposed within the interior of the compartment, may be extended outwardly through the access opening so as to grip letters, parcels, etc. contained within the interior of the mailbox by delivery personnel. Once gripped by the hand of the user covered by the handling assembly, the article may be passed into the interior of the compartment of the housing and isolated therein by closing the access opening, as set forth above.

Alternatively, substantially all or at least a majority of the housing is disposed on the interior of a conventional mailbox such that the access opening is somewhat aligned with the opening of the mailbox. As such, articles normally placed on the interior of the mailbox will be disposed through the access opening into the interior of the compartment of the housing. Delivery personnel and/or the proprietor of the mailbox can then orient the access opening in a closed position to isolate the articles within the interior of the compartment. Contact or direct exposure to the articles is thereby prevented. The isolation assembly and article contained therein are then concurrently removed from the interior of the mailbox.

It is recognized that a number of different contaminants may be distributed throughout the general population using the mail service, in the manner generally described above. Accordingly, in order to assure safe handling or physical examination of a contaminated article without fear of any exposure to the pathogens associated therewith, the isolation assembly of the present invention is formed, in whole or in part, from a material which is impermeable to at least a significant variety of pathogens. In addition, such material should be at least partially flexible to facilitate the intended physical examination while at the same time being strong, durable and resistant to any type tear, puncture or like failure which would have a tendency to violate the isolated, hermetically sealed compartment.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of one preferred embodiment of an isolation assembly of the present invention.

FIG. 2 is a perspective view of another preferred embodiment of the isolation assembly of the present invention.

FIG. 3 is a perspective view of yet another preferred embodiment of the isolation assembly of the present invention.

FIG. 4 is a perspective view of yet another preferred embodiment of the isolation assembly of the present invention.

FIG. 5 is a perspective view of yet another preferred embodiment of the isolation assembly of the present invention.

FIG. 6 is a perspective view of yet another preferred embodiment of the isolation assembly of the present invention.

FIG. 7 is a perspective view of yet another preferred embodiment of the isolation assembly of the present invention.

FIG. 8 is a perspective view of yet another preferred embodiment of the isolation assembly of the present invention.

FIG. 9 is a perspective view of yet another preferred embodiment of the isolation assembly of the present invention.

FIG. 10 is a perspective view in partial cutaway disclosing the physical examination of an article contained within the isolation assembly of the present invention.

FIG. 11 is a perspective view of yet another preferred embodiment of the isolation assembly of the present invention.

FIG. 12 is a perspective view of yet another preferred embodiment of the isolation assembly of the present invention.

FIG. 13 is a perspective view of at least one embodiment of the isolation assembly associated or used in combination with a conventional mailbox.

FIG. 14 is a perspective view of the isolation assembly used in association with a conventional mailbox and oriented in a position differing from that of the embodiment of FIG. 13. and,

FIG. 15 is a perspective view of yet another preferred embodiment of the isolation assembly of the present invention.

Like reference numerals refer to like parts throughout the several views of the drawings.

### DETAILED DESCRIPTION OF THE PREFERRED EMBODIMENT

As shown in the accompanying Figures, the present invention is directed to an isolation assembly which is generally indicated as 10 and which includes a housing 12. The housing 12 is structured to include and define an at least partially hollow compartment 14 disposed on the interior thereof. In addition, an access opening generally indicated as 16 is disposed in direct communication with the interior compartment 14. The access opening 16 is dimensioned and configured to allow passage of one or more various types of articles 20 (see FIG. 10) therethrough, such that the article 20 may be selectively disposed into or out of the interior compartment 14.

As also disclosed in FIG. 10, the housing 12 is at least partially formed from a transparent material so as to allow a clear viewing of the article 20 as it is being examined. Accordingly, the housing may be formed substantially entirely of transparent material such that the article 20 can be viewed from different exterior positions. Alternatively, at least a portion of the housing, such as one of the front, rear or side panels thereof, can preferably be formed from a darkened, opaque or translucent material which facilitates the viewing of materials which may normally be difficult to visually examine, such as powders or the like. The darkened opaque or translucent panels formed as part of the housing 12 may thereby serve as a “back drop” in order to facilitate viewing of a light colored powder or other material.

While the isolation assembly 10 is intended to provide the safe handling of any of a variety of different articles, one primary purpose is to provide for the safe examination of letters, parcels, packages, etc. which have been or are intended to be distributed or processed by the postal service of a country and/or by a mail handling department or a large company. More specifically, the various preferred embodiments of the present invention are intended to provide for the receipt and/or physical examination of a contaminated article or an article which may potentially be contaminated, in an isolated environment. The fear of direct contact with and/or exposure to any contaminated material associated with an article being examined is thereby lessened or eliminated.

In order to increase the functional versatility of the various preferred embodiments of the isolation assembly 10, the housing 12 may have a variety of different dimensions and configurations. Any number of differently sized and configured articles may therefore be safely examined. In turn, the interior compartment 14 and the access opening 16 will have their respective dimensions and configurations correspond to the overall dimension and configuration of the housing 12 with which they are associated.

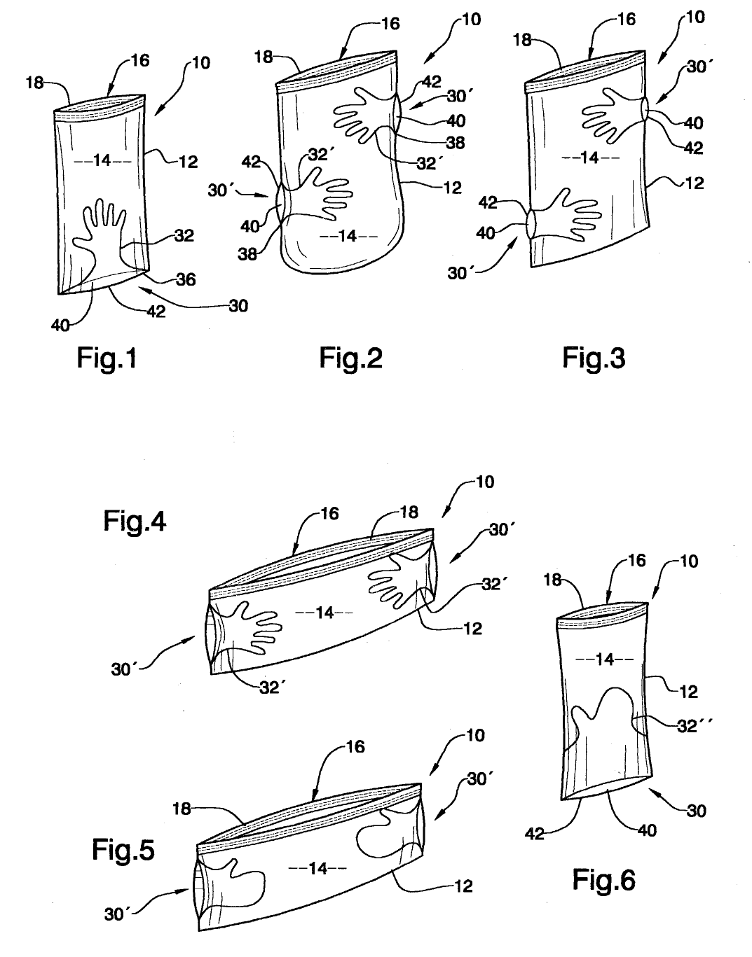

The access opening 16 is selectively disposable between an open position and a closed position. In order to facilitate such positioning of the access opening 16, it may be directly associated and cooperatively structured with a closure assembly 18. The closure assembly 18 is structured to accomplish an effective, air tight seal in order to maintain the interior of the compartment 14 and any article or articles 20 contained therein in a hermetically isolated environment defined by the confines of the housing 12 and specifically the compartment 14. As shown in FIGS. 1 through 6, 8 and 15 the closure assembly 18 may assume an elongated, lock type seal wherein the peripheral edges corresponding with or mounted contiguous to the access opening 16 may be interlocked with one another in an air tight fashion.

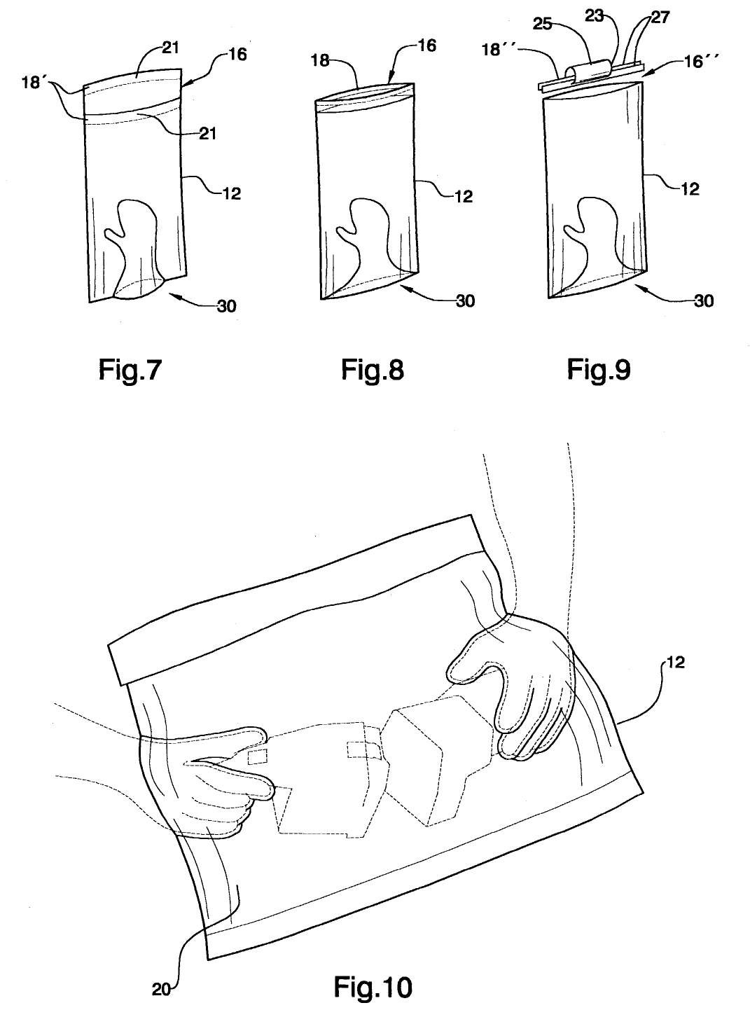

With reference to FIG. 7 and 9 through 12, different structural embodiments of the closure assembly 18′ and 18″ respectively are demonstrated. With respect to the preferred embodiments of FIGS. 7, 1 1 and 12, the closure assembly 18′, associated with the access opening 16′, may include one or more adhesive strips 21. The size, dimension, disposition and composition of the adhesive and/or adhesive strips 21 is such as to assure the aforementioned hermetic seal being formed along the entirety of the access opening 16′.

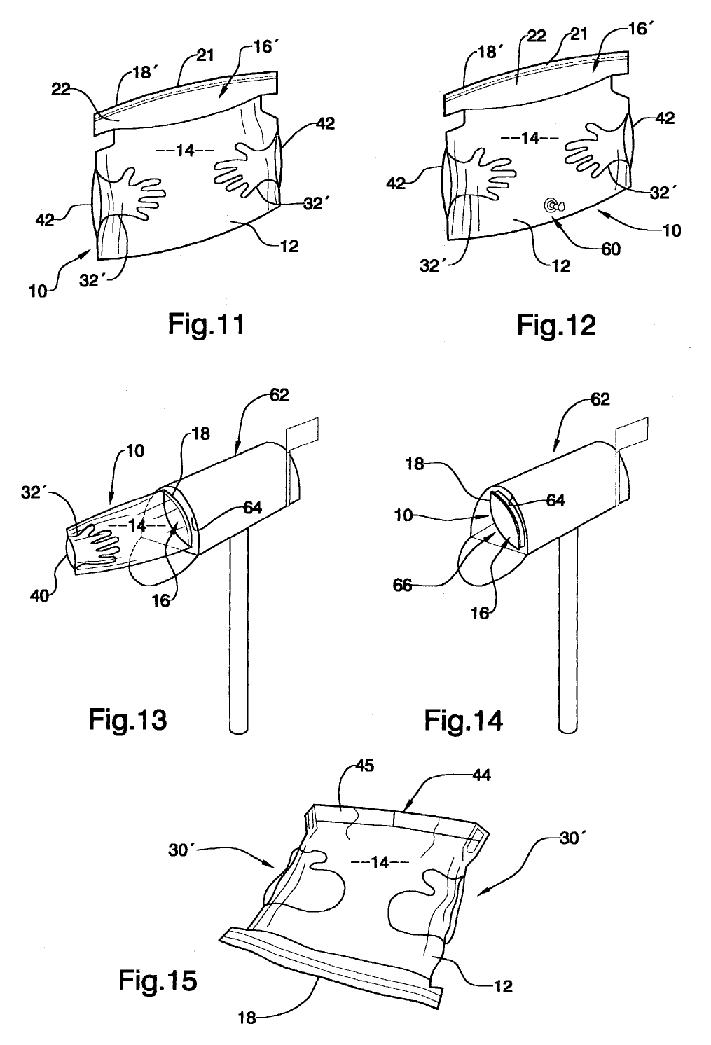

As shown in FIG. 11 and 12, at least one adhesive strip 21 may be formed or mounted on an interior surface of a flap structure 22. The flap structure 22 includes an enlarged dimension so as to extend along and preferably beyond the entire length of access opening 16′ to further assure the establishment of an air tight seal. With reference to FIG. 9, the closure assembly 18″ comprises a locking clip or like structure 23 which may be normally biased in a closed position by a biasing element 25. The biasing element 25 serves to normally clamp the locking arms 27 into engaging relation with one another. The closure assembly 18″ may or may not be initially attached to the housing 12. However, in any case the biased arms 27 will clamp together peripheral portions or edges of the access opening 16″ in an air tight manner. It is again emphasized that closure assemblies 18, 18′ and 18″ are not meant to be exhaustive of the various structures that can be used in direct association with the access openings 16′ or 16″ in order to accomplish the required air tight seal and the resulting hermetic isolation of the interior compartment 14. Clearly other types of closure assemblies can be utilized.

Another feature of the present invention is the provision of a handling assembly generally indicated as 30 and 30′. The handling assembly 30, 30′ is disposed and structured to facilitate the handling, manipulation and overall physical examination of one or more articles 20 once disposed within the interior compartment 14. Each of the preferred embodiments of the handling assembly 30, 30′ are distinguishable from one another and comprise a single hand cover 32 or a plurality of hand covers 32′. Each of the hand covers 32 and 32′ are structured to be normally disposed in an operative position comprising an inwardly extended orientation thereof into the interior compartment 14. The operative position is further defined by each of the hand covers 30 and 30′ including a contact surface disposed within the compartment 14 in segregated relation to an interior, hand receiving portion of each hand cover 30, 30′.

As shown in the embodiments of FIGS. 1 and 6 through 9 each of the hand covers 32 may extend inwardly from an end peripheral edge or portion 36 into the compartment 14. Alternatively, the handling assembly 30 or 30′ may include one or more hand covers 32′ extending inwardly from laterally disposed peripheral portions 38. In either embodiment the hand covers 32 and/or 32′ are disposed at least a predetermined spaced distance from the access opening 16 so as to at least partially restrict the ability to pass or position the various hand covers 32 or 32′ through the access opening 16 to the exterior of the housing 12. Inadvertent contamination of the surrounding area or environment on the exterior of the housing 12 is thereby reduced or prevented.

With reference to FIGS. 4 and 5, the at least two hand covers 32′ are each located in substantially opposed relation to one another and in somewhat longitudinal axial alignment. Further in this embodiment the access opening 16 is oriented in a substantially parallel relation to the length and/or axial alignment of the two hand covers 32′ as clearly shown. Alternatively, in the embodiment of FIGS. 1 and 6 through 9 the access opening 16 is located in spaced relation to the respective hand covers 32 and is disposed in somewhat transverse orientation to the length of the respective hand covers 32. In the embodiments of FIGS. 2 and 3 the hand covers 32′ are located in a non-aligned or off-set relation to one another, wherein both the hand covers 32′ are spaced from another and from the access opening 16 as set forth above.

The specific dimension and configuration of each of the hand covers 32, 32′ should be such as to receive a hand of a user therein as clearly demonstrated in FIG. 10. Accordingly, each of the hand covers 32, 32′ include an interior portion 40 and an opening 42 disposed and dimensioned to allow passage of a users hand therethrough into and out of the interior portion 40. Another feature associated with the various embodiments of the hand covers 32 and 32′ is the versatility in their respective configurations. As such, the hand covers 32 or 32′ may be at least partially ergonomically configured such as by having a multiple finger glove-file structure and configuration demonstrated in FIGS. 1 through 4. Also, hand covers 32 or 32′ may assume partial ergonomically configured mitten-like structures as demonstrated in FIGS. 5 and 7 through 9.

Alternatively, the configuration of the hand cover 32′ may comprise a more abstract or non-defined configuration which is not limited to a multi-fingered configuration as in the embodiments as noted above. Regardless of the specific hand cover 32, 32′ or 32″, utilized the configuration thereof is such as to facilitate the physical examination, manipulation and handling of one or more articles 20 in the manner clearly disclosed in FIG. 10 so as to determine whether or not the article 20 contains or has associated therewith any type of contaminated substance.

In order to provide complete assurance of safe and isolated handling of one or more articles 20, another feature of the present invention is the formation of the isolation assembly 10, preferably in its entirety, from a material which is impermeable to a wide variety of pathogens. Pathogens of the type referred to may be directly associated with contaminants contained in or associated with one or more articles 20 disposed within the interior compartment 14. It is acknowledged that certain operative components, such as, but not limited to the closure assembly 18″ may in fact not be formed of such a pathogen impermeable material. However, all components and structures associated with the isolation assembly 10 which serve to maintain the interior compartment 14 and any article 20 contained therein in a hermetically sealed environment are formed of a pathogen impermeable material. Such material should be specifically structured to prevent the passage or transmission there through of any pathogens associated with aerosol and/or particulate contaminants.

Accordingly, the housing 12, each of the one or more hand covers 32 and 32′, the access opening 16 and any closure assembly integrally or directly associated therewith are preferably formed of the aforementioned pathogen impermeable material. Such materials are known and commercially available and also demonstrate the physical and operative characteristics of being at least partially flexible, durable and resistant to punctures, tears, rips other failures which would violate the isolated containment of contaminants within the interior compartment 14. In all embodiments, hand covers may have any appropriate configuration to receive the hands of a user and for permitting an easy manipulation of the article contained in the assembly.

Yet another preferred embodiment of the present invention is shown in FIG. 12 wherein in addition to the enlarged flap 22 having at least one adhesive strip 21 mounted thereon, the isolation assembly 10 and in particular the housing 12 includes a valve assembly generally indicated as 60. The valve assembly 60 may be defined by any number of structural configurations which are disposed and structured to regulate fluid flow both into and out of the interior compartment 14. The primary purpose of the valve assembly 60 is to provide for at least one method of decontamination of the interior of the compartment 14 and any article isolated therein. More specifically a pressurized decontaminating fluid in the form of an gas, aerosol, liquid spray, etc. can be introduced into the interior of the compartment 14 when the access opening 16, 16′ and an associated closure assembly 18, 18′ 18″ is disposed in the aforementioned closed position.

Accordingly, an article contained within the compartment 14 will remain hermetically isolated. However, the introduction of the decontaminating fluid, under pressure through the valve structure 16 will serve to sanitize the article and any pathogens associated therewith. Further, the valve structure 60 is capable of allowing the interior of the compartment 14 to be evacuated, such as by securing a source of negative pressure or vacuum to the valve structure 16 and withdrawing any fluid, gas, aerosol, contaminants, pathogens, etc. contained within the interior of the compartment 14.

The versatility of the isolation assembly 10 is further demonstrated in FIGS. 13 and 14. Moreover, the isolation assembly 10 as shown in FIG. 13 may be disposed such that the hand cover 32′ may pass through an access opening 16 which is aligned within the interior 64 of a conventional mailbox 62. In such a position a user's hand may pass into the interior portion 40 of the hand cover 32′ and be forced through the access opening 16 into the interior 66 of the mailbox 62 through the opening 64 thereof. The mail or any other article within the interior 66 of the mailbox 62 will be gripped by the hand within the interior portion 40 of the hand cover 32′ and withdrawn from the mailbox into the interior compartment 14. Once disposed therein the access opening 16 and/or closure assembly 18 associated therewith may be oriented in a closed positioned to isolate the contents received from the mailbox 62 into the interior compartment 14.

Alternatively, the entire isolation assembly 1 0, or at least a majority thereof may be disposed within the interior 66 of the mailbox 62 by passing the housing 12 through the opening 64 thereof. When located on the interior 66, the isolation assembly 10 may have the access opening 16 disposed in aligned and in article receiving relation to the opening 64. As such, articles being delivered to the mailbox 62 can be disposed directly into the interior compartment 14 through the access opening 16. The access opening 16 and associated closure assembly 18 can thereafter be oriented in the closed position for isolation of the article within the interior compartment 14. Still according to another embodiment of the present invention, FIG. 15 shows a perspective view of an isolation assembly 10 which may be of the type illustrated in FIGS. 4, 5, defining a compartment 14 and handling means 30′. This embodiment, however, defines a bottom 44 including expansion means 45 which may comprise a cardboard piece arranged at the bottom of the assembly with the purpose of remaining collapsed when the assembly is not in use and deployed, when the assembly is in use, in such a manner that the interior volume of compartment 14 is increased enough to easy the manipulation of any article housed into the assembly. Cardboard 45 may be adhered or simply retained at bottom 44, may extend all along or partially along bottom 44 and or may extend also partially along sides of the assembly, as illustrated in FIG. 15.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. An isolation assembly structured to provide safe handling of a potentially contaminated article, said isolation assembly comprising:
a) a housing at least partially formed of a transparent material and including an at least partially hollow interior compartment,
b) an access opening formed on said housing and selectively disposable between an open position and a closed position,
c) a handling assembly movable within said compartment in manipulating engagement with the article disposed therein, and
d) said housing and said handling assembly formed of a pathogen impermeable material, and cooperatively structured with said access opening to hermetically isolate said compartment when said access opening is in said closed position.

2. An isolation assembly as recited in claim 1 wherein said handling assembly comprises at least one hand cover disposed within said compartment in spaced relation to said access opening.

3. An isolation assembly as recited in claim 2 further comprising a connecting structure disposed to secure said hand cover within said compartment in an operative position, said operative position being restrictive to passage of said hand cover through said access opening.

4. An isolation assembly as recited in claim 2 wherein said hand cover comprises a contact surface disposable in engageable relation to the article and maintained within said compartment when said hand cover is in said operative position.

5. An isolation assembly as recited in claim 4 wherein said hand cover comprises an entrance structure disposed in communicating relation between an interior of said hand cover and an exterior of said compartment.

6. An isolation assembly as recited in claim 5 wherein said hand cover is formed from an air and pathogen impermeable material and disposed to isolate said hand cover interior from said compartment and any particulate or aerosol contaminants contained within said compartment.

7. An isolation assembly as recited in claim 4 wherein said hand cover comprises an ergonomically configured construction.

8. An isolation assembly as recited in claim 4 wherein said ergonomically configured construction comprises a multi-fingered configuration.

9. An isolation assembly as recited in claim 1 wherein said access opening comprises a closure assembly secured thereto, said closure assembly selectively oriented to define either said open position or said closed position of said access opening.

10. An isolation assembly as recited in claim 9 wherein said closure assembly is structured to prevent aerosol contaminants from passing from said compartment through said access opening when said closure assembly is in said closed position.

11. An isolation assembly as recited in claim 1 wherein said locking structure and said access opening are dimensioned and configured to allow passage of the article there through into and out of said compartment.

12. An isolation assembly structured to provide safe handling of a potentially contaminated article, said isolation assembly comprising:
a) an at least partially transparent housing including an at least partially hollow interior compartment, said hollow interior of said compartment viewable through at least a portion of said housing,
b) an access opening formed on said housing and including a closure assembly disposed contiguous to said access opening and selectively disposable between an open position and a closed position,
c) at least one hand cover disposed in an operative position within said compartment and including a contact surface disposed to engage the article within said compartment,
d) said housing and said one hand cover formed of a material restrictive of aerosol or particulate pathogens passing there through, and
e) said access opening structured to further hermetically isolate said compartment when in said closed position.

13. An isolation assembly as recited in claim 12 further comprising a plurality of hand covers each disposed in an operative position in predetermined spaced relation to one another and to said access opening within said compartment.

14. An isolation assembly as recited in claim 13 wherein each of said hand covers include an interior portion dimensioned and configured to receive a hand of a user therein.

15. An isolation assembly as recited in claim 14 wherein each of said hand covers include a contact surface positioned exteriorly of said interior portion and in exposed engageable relation to the article within said compartment.

16. An isolation assembly as recited in claim 15 wherein each of said hand covers is formed of a material impermeable to aerosol or particulate carried pathogens such that said interior portions of each of said hand cover is isolated from contaminants within said comportment.

17. An isolation assembly as recited in claim 13 wherein at least two of said plurality of hand covers extend inwardly into said compartment in spaced and substantially axially aligned relation to one another.

18. An isolation assembly as recited in claim 17 wherein said two hand covers extend inwardly from substantially oppositely disposed lateral portions of said compartment.

19. An isolation assembly as recited in claim 17 wherein said two hand covers extend inwardly from substantially oppositely disposed end portions of said compartment.

20. An isolation assembly as recited in claim 13 wherein at least two of said plurality of hand covers extend inwardly into said compartment in spaced, substantially non-aligned relation to one another.

21. An isolation assembly as recited in claim 20 wherein said two hand covers extend inwardly from substantially oppositely disposed lateral portions of said compartment.

22. An isolation assembly as recited in claim 20 wherein said two hand covers extend inwardly from substantially oppositely disposed end portions of said compartment.

23. An isolation assembly as recited in claim 17 wherein said access opening extends along at least a majority of one end of said compartment in contiguous relation to a peripheral portion of said compartment.

24. An isolation assembly as recited in claim 17 wherein said access opening extends along a majority of one lateral peripheral edge of said compartment.

25. An isolation assembly as recited in claim 17 wherein said access opening extends along and in contiguous relation to a peripheral portion of said compartment and in substantially parallel relation to an extended length of said two hand covers.

26. An isolation assembly as recited in claim 12 further comprising a valve assembly connected to said housing in fluid communication with said compartment, said valve assembly structured to regulate fluid flow into and out of said compartment.

27. An isolation assembly as recited in claim 12 wherein said housing is operatively disposed relative to the interior of a mailbox.

28. An isolation assembly as recited in claim 27 wherein said housing is disposed within the mailbox and said access opening is disposed in receiving relation to articles passing into said mailbox, said access opening being initially in said open position prior to receiving the articles and selectively disposable into said closed position subsequent to receiving the articles within said compartment.

29. An isolation assembly as recited in claim 1, further defining a bottom including expansion means comprising a cardboard piece arranged at the bottom, the cardboard piece remaining collapsed when the assembly is not in use and deployed, when the assembly is in use, in such a manner that a volume of the compartment is increased enough to easy the manipulation of any article housed into the assembly.

30. An isolation assembly as recited in claim 12, further defining a bottom including expansion means comprising a cardboard piece arranged at the bottom, the cardboard piece remaining collapsed when the assembly is not in use and deployed, when the assembly is in use, in such a manner that a volume of the compartment is increased enough to easy the manipulation of any article housed into the assembly.
